(19) United States
(12) Patent Application Publication
(10) Pub. No.: US 2014/0282790 A1
(43) Pub. Date: Sep. 18, 2014

(54) SYSTEMS AND METHODS FOR AVOIDING MISSING TELEVISION PROGRAMMING WHEN CHANGING BETWEEN TELEVISION CHANNELS

(71) Applicants: ELDON TECHNOLOGY LIMITED, Keighley (GB); ECHOSTAR TECHNOLOGIES L.L.C., Englewood, CO (US)

(72) Inventors: Mark Benedict Stephens, West Yorkshire (GB); Michael John Bazata, Elizabeth, CO (US)

(73) Assignees: ECHOSTAR TECHNOLOGIES L.L.C., Englewood, CO (US); ELDON TECHNOLOGY LIMITED, Keighley (UK)

(21) Appl. No.: 13/839,195

(22) Filed: Mar. 15, 2013

(51) Int. Cl. H04N 21/44; H04N 21/433

(52) U.S. Cl. CPC H04N 21/44004; H04N 21/433
USPC 725/116

(57) ABSTRACT

A buffering and playback manager of a receiving device facilitates a user avoiding missing television programming on a television (TV) channel when the user is changes to another TV channel. When a user returns to a previously visited TV channel, the TV channel buffering and playback manager 100 is configured to continue the television programming from a point the TV program was at when the user had de-selected that TV channel. The TV programming of the previously visited TV channel starts or continues to be stored in a buffer when the receiving device de-selects that TV channel. Upon returning to that TV channel, the TV program data stored in the buffer is played on the TV channel instead of the live broadcast being played on that TV channel.

### TECHNICAL FIELD

The technical field relates to digital video and more particularly, to apparatus, systems, and methods for avoiding missing television (TV) programming.

### BRIEF SUMMARY

In one embodiment, a buffering and playback manager of a receiving device facilitates a user avoiding missing television programming on a TV channel when the user changes to another TV channel. For example, when a user returns to a previously visited TV channel, the TV channel buffering and playback manager is configured to continue the television programming from a point the television program was at when the user had de-selected that TV channel. Definitions of terms and phrases used herein to describe and claim various embodiments appear below.

A “data stream”, “data bitstream” or “digital bitstream” as used herein means: an information signal that is a sequence of digitally encoded coherent signals used to transmit or receive information and which may be structured into packets of data or data packets.

An “elementary stream” or an “elementary data stream” as used herein means: a data bitstream that contains one kind of data, e.g., audio or video. For example, this data bitstream may originate as the output of a video or audio encoder. A particular elementary stream may also be referred to as an “elementary”, “audio”, or “video” bitstream or stream.

A “TV channel”, e.g., that which is provided by a television network such as, for example, BBC 1, NBC, BBC World or CNN, etc., and also referred to herein as a “service” or a “program” means: a set of synchronized audio, video, subtitle and/or other data streams, which are elementary streams intended for presentation on a presentation device. A TV channel may comprise multiple streams of each type. One or multiple streams of each type may be presented at a time. For example, only the English language audio stream or only the Spanish language audio stream of a TV channel may be presented. As another example, multiple streams of each type may be combined or mixed for presentation such as the audio-description audio stream mixed with the English language audio stream. In some instances, only a subset of the streams may be presented, e.g., a video stream and an audio stream, but not subtitles. Also, it may be that a service only carries and audio elementary stream if it is a Radio TV channel.

A “TV program” as used herein means: one of a sequence of events into which a “TV channel” (i.e., a “service” or “program”) may be subdivided. A TV program may correspond, e.g., to a film, a news broadcast, a soap opera or quiz show, etc. Also, a TV program, as used herein, may correspond radio programming and streaming of live or previously recorded events. “Playing TV program content on a TV channel” means outputting the TV program, or stored TV program, of the corresponding TV channel for presentation on a presentation device.

“TV programming” as used herein is a general reference to TV programs on TV channels.

A “channel” or “communication channel” as used herein means: either a physical transmission medium such as a wire, or a logical connection over a multiplexed medium, such as a radio frequency (RF) channel. A channel is used to convey an information signal, for example, a TV channel or other types of data streams, from one or several senders (or transmitters) to one or several receiving devices. A channel has a certain capacity for transmitting information, often measured by its bandwidth in Hz or its data rate in bits per second. For example, a channel may refer to a frequency band in which information is signalled. For analogue TV, a single TV channel is broadcast in a single RF channel. For digital TV, a single RF channel may have multiple TV channels (i.e., services or programs) broadcast together. This broadcast is typically performed by packetizing each of the elementary streams that comprise a TV program (i.e., a service or TV channel) then multiplexing the packets with the synchronization data (e.g., the Program Clock Reference) that enables the de-packetized streams to be decoded and presented in synchronization and correct order to reconstruct the TV channels (i.e., the services or programs) as desired.

The TV programming of the previously visited TV channel starts or continues to be stored in a buffer when the receiving device de-selects that TV channel. The phrase “de-select a TV channel” as used herein includes various forms of de-selecting a TV channel including, but not limited to, switching to presentation of a different TV channel, tuning to a different TV channel, changing to a different TV channel, etc. Upon returning to presentation of that TV channel, the TV program data stored in the buffer is presented from the point in time of the previous TV channel change instead of the TV channel (i.e., the live broadcast service) being presented. Data indicative of a point the TV program was at when the receiving device de-selected the TV program from being presented may be stored by the receiving device. This data may be used by the receiving device to determine at which point within the buffer to start to play the TV programming when the user returns to the TV channel.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating an example content distribution environment in which embodiments of systems and methods for facilitating a user avoiding missing television programming when changing between TV channels may be implemented, according to one embodiment.

FIG. 2 is a block diagram illustrating example functional elements of systems and methods for facilitating a user avoiding missing television programming when changing between TV channels, according to one embodiment.

FIG. 3 is a block diagram of a computing system for practicing example embodiments of systems and methods for facilitating a user avoiding missing television programming when changing between TV channels, according to one embodiment.

FIG. 4 is a timeline chart illustrating an example operation of a TV channel buffering and playback manager when changing between TV channels, according to one embodiment.

FIG. 5 is a flow diagram of first example method for facilitating a user avoiding missing television programming when changing between TV channels, according to one embodiment.

FIG. 6 is a flow diagram of second example method for facilitating a user avoiding missing television programming when changing between TV channels, according to one embodiment.

FIG. 7 is a flow diagram of third example method for facilitating a user avoiding missing television programming when changing between TV channels, according to one embodiment.

### DETAILED DESCRIPTION

FIG. 1 is a block diagram illustrating an example content distribution environment in which embodiments of systems and methods for facilitating a user avoiding missing television programming may be implemented, according to one embodiment. Shown in FIG. 1 is a TV channel buffering and playback manager 100. When using the receiving device 118, the user may switch between multiple TV channels. When a user returns to a previously visited TV channel, the TV channel buffering and playback manager 100 may continue the television programming from a point the TV program was at when the user had left the TV channel. In this example, the TV channel buffering and playback manager 100 operates upon the receiving device 118 and is configured to detect when the user de-selects the current TV channel from being presented and to start or continue to buffer that TV channel. The TV channel buffering and playback manager 100 may calculate, store and access statistics regarding the various TV channels visited and programming played on those TV channels, as well as information regarding buffer memory usage and constraints, and network interface usage and constraints, such that when a user returns to a TV channel, the television programming continues from a point the TV program was at when the user had left the TV channel.

Before providing additional details regarding the operation and constitution of the TV channel buffering and playback manager 100, the content distribution environment 102 of the TV channel buffering and playback manager 100 will briefly be described.

In the content distribution environment 102, audio, video, and/or data service providers, such as, but not limited to, television service providers, provide their customers a multitude of TV programming. Such TV programming is often provided by use of a receiving device 118 communicatively coupled to a presentation device 120 configured to receive the TV programming.

The receiving device 118 interconnects to one or more communications media or sources (such as a cable head-end, satellite antenna, telephone company switch, Ethernet portal, off-air antenna, or the like) that provide the TV programming. The receiving device 118 commonly receives a plurality of TV programming on various TV channels by way of the communications media or sources described in greater detail below. Based upon selection by a user, the receiving device 118 processes and communicates the selected TV programming to the presentation device 120. For example, the receiving device 118 may be, or be part of, a device such as a television converter, set-top box, television receiving device, television recording device, satellite set-top box, satellite receiving device, cable set-top box, cable receiving device, media player, mobile device, smart phone, computer, tablet device, and/or television tuner. Accordingly, the receiving device 118 may be any suitable converter device or electronic equipment that is operable to receive or playback TV programming.

Further, the receiving device 118 may itself include user interface devices, such as buttons or switches to provide user control of the receiving device and the functionalities described herein. In many applications, a remote-control device (“remote”) 128 is operable to control the receiving device 118 and/or the presentation device 120. The remote 128 typically communicates with the receiving device 118 using a suitable wireless medium, such as infrared (“IR”), radio frequency (“RF”), or the like.

Examples of a presentation device 120 include, but are not limited to, a television (“TV”), a personal computer (“PC”), a sound system receiving device, a mobile device, a game system, or the like. Presentation devices 120 may employ a display, one or more speakers, and/or other output devices to communicate video and/or audio content to a user. In many implementations, one or more presentation devices 120 reside in or near a customer's premises 116 and are communicatively coupled, directly or indirectly, to the receiving device 118. Further, the receiving device 118 and the presentation device 120 may be integrated into a single device. Such a single device may have the above-described functionality of the receiving device 118 and the presentation device 120, or may even have additional functionality.

A content provider 104 provides TV program content to a distributor, such as the TV program distributor 106. Example content providers include television stations which provide local or national television programming, special content providers which provide on-demand TV programming, premium based TV programming and/or pay-per-view TV programming.

TV program content, also referred to herein as TV programming or content of TV programs, is communicated to the TV program distributor 106 from the TV content provider 104 through suitable communication media providing various communication TV channels, generally illustrated as communication system 108 for convenience. Communication system 108 may include many different types of communication media, now known or later developed. Non-limiting media examples include telephony systems; the Internet; internets; intranets; local area network (“LAN”) systems; Internet Protocol (IP) systems; terrestrial television systems; digital terrestrial television (DTTV) systems; digital television terrestrial broadcasting (DTTB) systems; cable systems; fiber optic systems; microwave systems; asynchronous transfer mode (“ATM”) systems; frame relay systems; digital subscriber line (“DSL”) systems; Digital Video Broadcasting (DVB) systems over cable, satellite, terrestrial and mobile networks, including, but not limited to, Digital Video Broadcasting-Cable (DVB-C or DVB-C2), Digital Video Broadcasting-Satellite (DVB-S), Digital Video Broadcast-Satellite services to Handheld, (DVB-SH), Digital Video Broadcast-Return Satellite via Satellite (DVB-RCS), Digital Video Broadcasting-Terrestrial (DVB-T or DVB-T2), Digital Video Broadcasting-Handheld (DVB-H) and other variants; Direct-broadcast Satellite (DBS) systems; direct-to-home signals (DTH); Advanced Television Systems Committee (ATSC) systems; Digital Terrestrial Multimedia Broadcasting (DTMB) systems; Data Over Cable Service Interface Specification (DOCSIS) and EuroDOCSIS systems; and other radio frequency (“RF”) systems and satellite systems.

In at least one embodiment, the received TV program content is converted by the TV program distributor 106 into a suitable signal (i.e., a “program signal”) that is communicated (i.e., “uplinked”) by one or more antennae 110 to one or more satellites 112 (separately illustrated herein from, although considered part of, the communication system 108). The communicated uplink signal may contain a plurality of multiplexed programs. The uplink signal is received by the satellite 112 and then communicated (i.e., “downlinked”) from the satellite 112 in one or more directions, for example, onto a predefined portion of the planet.

A receiving device antenna 114 that is within reception range of the downlink signal communicated from satellite 112 receives the above-described downlink signal. The receiving device antenna 114 can be located at customer premises 116. Examples of customer premises 116 include a residence, a business, or any other suitable location operable to receive signals from satellite 112. The received signal is communicated, typically over a hard-wire connection, to a receiving device 118. The receiving device 118 converts the received signal from antenna 114 into a signal and/or format suitable for communication to a presentation device 120 or another device, such as another digital video recorder or a home computing system.

For example, receiving device 118 may be a digital receiving device with an RF network interface (e.g., satellite, terrestrial, or cable) that tunes to the RF channel and reject signals from other RF channels, demodulates the signals to a bit-stream then de-multiplexes the packets and filters for the packets carrying the elementary streams of the TV channel and other data for decryption, decoding and presentation as a service. In some embodiments, the receiving device may typically process only the packets of the elementary stream for the TV channels being watched or recorded. A digital receiving device with an RF network interface, in some embodiments, may have one or multiple tuners and demodulators, each capable of selecting a single RF channel and converting it into a bit stream or it may have a wide band tuner/demodulator capable of demodulating the bit-streams from several RF channels simultaneously. These one or multiple bit-streams are then de-multiplexed and filtered to provide one or multiple elementary streams which are used to reconstruct the TV channels, Radio TV channels, data services (i.e., services or programs) using metadata (e.g., the Program Map Table (PMT)) transmitted alongside the elementary streams that map the elementary streams into programs (i.e., services or TV channels). For example, the PMT may provide information to the receiving device 118 regarding which packet identifiers (IDs) to filter in order for the receiving device 118 to collect the packets of the elementary stream belonging to that program (i.e., TV channel).

The receiving device 118 may have one or more presentation interfaces (e.g., such as that provided by the playback module 312 shown in FIG. 3) to output the same or multiple services to one or multiple display devices, such as presentation device 120. The receiving device 118 may have a recording capability, such as the buffering module 311 shown in FIG. 3) to buffer the data of the elementary streams of a service for subsequent presentation or forwarding. The receiving device 118 may have a network interface, such as the network connections 306 shown in FIG. 3, to forward a service to a remote presentation device for presentation or to a remote recording device for buffering.

In some embodiments, the receiving device 118 may be a digital receiving device with an Internet Protocol (IP) network interface that is similar to a digital receiver with a RF network interface, but it does not need the RF tuning and demodulation capability, except in some cases such as where the IP interface is a Data Over Cable Service Interface Specification (DOCSIS) cable modem interface. Packets are received through the IP interface and are filtered to extract the elementary streams of the services to be received.

An IP digital receiver further differs from a digital receiver with a RF network interface because the IP interface is a two way communication TV channel enabling the receiving device 118 to communicate with the devices upstream of the network interface to select different services to be sent over the IP network or to pause, fast forward or rewind the services sent, and to collaborate with upstream devices to implement buffering and playback of content by devices upstream before they are sent to the receiving device.

In some embodiments, the receiving device 118 may be a hybrid digital receiver, which has both RF network and IP network interfaces, which may be included in the network connections 306 shown in FIG. 3, and has the properties of both types of receivers. The hybrid digital receiver additionally may use the two way communication capabilities of the IP network to select different services to be sent over the RF network or to pause, fast forward or rewind the services sent over the RF network and to collaborate with upstream devices to implement buffering and playback of content by devices upstream before they are sent to the receiver. In some embodiments, the receiving device antenna 114 may be remotely located from the customer premises 116. Thus, the receiving device 118 may receive TV programming partially from, or entirely from, another source other than the above-described receiving device antenna 114, and embodiments of the receiving device 118 may receive TV programming from program distributors 106 and/or content providers 104 via locally broadcast RF signals, cable, fiber optic, Internet media, or the like.

In addition, information provider 138 may provide various forms of content and/or services to various devices residing in the customer premises 116. For example, information provider 138 may provide a Web page (or other information) to the receiving device 118 or other computing device. Information provider 138 may further perform or facilitate electronic commerce transactions.

In the illustrated example, the TV channel buffering and playback manager 100 operates upon the receiving device 118. When a user returns to a previously visited TV channel, the TV channel buffering and playback manager 100 is configured to continue the television programming from a point the TV program was at when the user had left that TV channel (e.g., by providing input or a command for the receiving device to de-select that TV channel and select a different TV channel).

The above description of the content distribution environment 102 and the customer premises 116, and the various devices therein, is intended as a broad, non-limiting overview of an example environment in which various embodiments of systems and methods for facilitating a user avoiding missing television programming may be implemented. FIG. 1 illustrates just one example of a content distribution environment 102 and the various embodiments discussed herein are not limited to such environments. In particular, content distribution environment 102 and the various devices therein, may contain other devices, systems and/or media not specifically described herein.

Example embodiments described herein provide applications, tools, data structures and other support to implement a TV channel buffering and playback manager 100 that facilitates avoiding missing television programming when changing between TV channels. Other embodiments of the described techniques may be used for other purposes, including storage and playback of data transmissions generally and locating reference points in stored video and/or audio data generally. In the following description, numerous specific details are set forth, such as data formats, code sequences, and the like, in order to provide a thorough understanding of the described techniques. The embodiments described also can be practiced without some of the specific details described herein, or with other specific details, such as changes with respect to the ordering of the code flow, different code flows, and the like. Thus, the scope of the techniques and/or functions described are not limited by the particular order, selection, or decomposition of steps described with reference to any particular module, component, or routine.

FIG. 2 is a block diagram illustrating example functional elements of systems and methods for facilitating a user avoiding missing television programming when changing between TV channels, according to one embodiment. In particular, FIG. 2 shows an example TV channel buffering and playback manager 100 executing on an example receiving device 118. Execution of and/or receiving device 118 otherwise utilizing logic 202 causes the TV channel buffering and playback manager 100 to perform the acts, functions, steps, and/or operations of the TV channel buffering and playback manager 100 described herein. The illustrated receiving device 118, which, for example, may be a set-top box, is communicatively coupled to a presentation device 120, to a TV program distributor 106 via communication system 108, and in some embodiments, directly or indirectly to a mobile device 208 of the user 220.

A user 220 may operate the receiving device 118 and/or the presentation device 120 using remote-control device 128 and/or the mobile device 208. In various embodiments, the mobile device 208 may be, but is not limited to, one or more of: a cellular telephone, presentation device 120, another presentation device, a handheld computing device, a smart phone, a personal digital assistant (PDA), a tablet computing device, a notebook computing device, netbook computing device, a mobile gaming device, a handheld computer, a television remote control, etc. In some embodiments, the mobile device 208 may also or instead be and/or operate as a receiving device instead of or in conjunction with receiving device 118, and/or include the TV channel buffering and playback manager 100 and applicable components thereof. In some embodiments the functionality of the remote control 128 and the mobile device may instead be included in one device.

In some embodiments, the TV channel buffering and playback manager 100 detects when the receiving device 118 de-selects or intends to de-select the current TV channel from being presented. At or near the point the user de-selects the current TV channel, if not already, the TV channel buffering and playback manager 100 starts to buffer the TV program being played on that TV channel, creating buffered TV program content 206, while the user is not tuned to that TV channel.

The TV channel buffering and playback manager 100 includes logic 202, a TV channel changing statistics file 204, and buffered TV program content 206 (or access thereto). The TV channel changing statistics file 204 may include one or multiple files and may include information and statistics, at least some of which are used by the TV channel buffering and playback manager 100. This information and statistics may be data regarding the various TV channels visited, i.e., tuned to or selected, by the receiving device 118 and TV programming played on those TV channels. For example, in many embodiments, this data regarding the various TV channels visited by the receiving device 118 and programming played on those TV channels may include, but is not limited to: information regarding one or more of: previous TV channels visited; programming played on previous TV channels visited; buffered or stored programming played on previous TV channels visited; times at which the user changed TV channels; points within different programming being played on various TV channels corresponding to when the user had de-selected those TV channels; how long the TV channels were visited; buffer or storage space allocation; total available buffer or storage space; remaining available buffer or storage space; remaining available network interface capacity (tuners, demultiplexing, filtering capacity, etc.) prioritization of recently visited TV channels for buffer or storage space allocation; etc. When the user returns to a previous TV channel the logic 202 of the TV channel buffering and playback manager 100 may access some or all of this data in the TV channel changing statistics file 204 to continue the television programming from a point the TV program was at when the user had left the TV channel.

In one embodiment, using the remote control 128, the user 220 interacts with the receiving device 118 to tune to a first TV channel playing a TV program transmitted by the TV program distributor 106 to the receiving device 118. In response to the receiving device 118 de-selecting the first TV channel from being presented, the logic 202 then causes the TV channel buffering and playback manager 100 of the receiving device 118 to initiate buffering of the TV program content being played on the first TV channel. Alternatively this initiation of buffering may be in response to receiving a command from the remote control device 128 to do so, or in response to an internally generated TV channel change from an “autotune reminder” or program or series booking. For example, the user may set a reminder for a specific event and request the receiving device 118 to automatically tune to the TV channel for the event, or the user may cause a set of autotune reminders to be set because the user has set a booking for an event or a TV series. In some embodiments, the user may enable such buffering by first selecting a button or other applicable user interface element on the remote control device 128 before changing each TV channel or alternatively to activate or toggle a preference setting for all or individual TV channels. In some embodiments, the remote control 128 may have a button or other user interface elements specifically designated for this purpose. In such an embodiment, the TV channel buffering and playback manager may receive the signal from the remote control 128 as a result of the corresponding user interface element being selected and then proceed to perform the buffering of TV program content as described herein. The TV channel buffering and playback manager 100 may also prompt the user first inquiring whether the user desires to start buffering of the TV program being played on the first TV channel when the user de-selects the first TV channel by displaying an applicable prompt on the presentation device 120 and/or playing an audio signal via a speaker of the presentation device 120, receiving device 118 or other speaker in response to or otherwise in conjunction with the user tuning away from the TV channel.

The buffered TV program content 206 may be stored on the receiving device 118 and is accessible by the TV channel buffering and playback manager 100. The buffered TV program content 206 may instead or also be stored on an external storage device (not shown) such as mobile device 208 or other external device, or on a device at location remote from the receiving device 118, accessible by the TV channel buffering and playback manager 100 of the receiving device 118 via the communication system 108 or other wired or wireless connection. In such instances when the buffered TV program content 206 is instead or also stored on a mobile device of the user or the like, the buffered TV program content 206 may also be played on the mobile device 208. For example, in one embodiment, when the user de-selects the first TV channel on the receiving device 118, or turns the receiving device 118 off, and then returns to the first TV channel on the mobile device 108 using the mobile device 208 as a receiving device, the mobile device 208 will start to play the buffered TV program content from the point the TV program was at when the user de-selected the TV channel or turned off the receiving device 118.

The mobile device 208 may receive such TV program content from the receiving device 118 or other receiving device on customer premises via a wired or wireless connection and/or from the TV program distributor 106 via communication system 108 in real time, near real time, or at a rate faster than real time. In some embodiments, the remote control 128 and/or receiving device 118 may communicate to the mobile device 208 when the user changes TV channels and/or selects a TV channel to be buffered such that the mobile device 208 will know when to start and/or stop buffering corresponding TV program content for the applicable TV channel. In other embodiments, the mobile device 208 may buffer whatever TV program content is currently being communicated to the mobile device 208 from the receiving device 118 via a wired or wireless connection and/or from the TV program distributor 106 via communication system 108. The TV program content may also be received by the mobile device 208 along with associated metadata including data indicative of the TV channel on which the currently received TV program content is being played or to be played, and/or any other applicable data such as that stored in TV channel changing statistics file 204. This data may be stored and/or accessed by the mobile device 208 such that the mobile device 208 can start to play the buffered TV program content from the point the TV program was at when the user de-selected the TV channel or turned off the receiving device 118.

When the user de-selects the first TV channel, the logic 202 of the TV channel buffering and playback manager 100 may cause the receiving device 118 to record or otherwise indicate the point the TV program being played on the first TV channel was at when the user de-selected it and initiate or continue to buffer the TV program content being provided on the first TV channel. For example, this indication may be in the form of a timestamp, time code, index value, frame number, and/or a frame indication associated with the TV program being provided or played on the first TV channel and is referred to herein generally as a time code. In some embodiments, Presentation Time Stamps (PTS) may be used as a source of the time code. PTS are time stamps included with the encoded video (e.g., Motion Picture Expert Groups (MPEG) encoded video) to indicate when a frame of video should be presented relative to other frames and to the System Time Clock (clock in the receiving device used against which the presentation of audio/video/subtitles/etc. are synchronized). This indication may be stored in the TV channel changing statistics file 204. Initiating buffering may include specifying a buffering event, which may specify values of parameters including, but not limited to, one or more of: associated TV channel, a TV program content identifier, buffering begin time, current time, current program time code, a time stamp, duration of program, buffer space allocation, available buffer space, etc., which may be used by the TV channel buffering and playback manager 100 to buffer the desired program as buffered TV program content 206. For example, the system to facilitate avoiding missing television programming when changing between TV channels can be applied on an event by event basis as well as a service by service selection described herein. For example, once an event such as a television program that has been selected by the receiving device 118 based on user input or by default operation has been entirely presented or is buffered pending presentation, then the network interface is free to tune, demodulate, demultiplex and/or filter for other events or services. For example, a user may be able to select or indicate particular TV programs which will be buffered such that when the user returns to the TV channel having that TV program, the TV program will continue from the point it was at when the user de-selected the TV channel, but for other programs, this procedure will not be performed, as selectable by the user. Applicable information as described above enabling such functionality may also be stored in the TV channel changing statistics file 204.

When the receiving device 118 returns to the first TV channel, the TV channel buffering and playback manager 100 starts playing programming on the display 210 of presentation device 120 from the point the TV program was at on the first TV channel when the user had left that TV channel, i.e., de-selected that TV channel. This may be accomplished by the TV channel buffering and playback manager 100 accessing the buffered TV program content 206 associated with the TV channel to which the user returned and accessing the TV channel changing statistics file 204 to find the point within buffered TV program content 206 from which to start playing the buffered TV program content 206. For example, the TV channel buffering and playback manager 100 may go to the point within buffered TV program content 206 indicated by the buffering begin time, program time code, a time stamp, etc. stored in the TV channel changing statistics file 204 associated with the buffered TV program content 206 of the TV channel to which the user returned. The TV channel buffering and playback manager 100 may then start playing the buffered TV program content 206 from that point by causing the receiving device 118 to present the buffered TV program content 206 on the presentation device 120.

In some embodiments, the user may make a selection on the remote control 128 or receiving device 118 to go to the current or “live” programming currently being broadcast on the first TV channel instead of or during playing of the buffered TV program content 206. In some embodiments, upon returning to the first TV channel, the user may be prompted by the TV channel buffering and playback manager 100 to indicate whether the user wants to return to the point in the TV programming on the first TV channel where the user had left off or instead go to the current or “live” programming currently being broadcast on the first TV channel. This prompt may be communicated in various manners, including but not limited to displaying the prompt on the display 210 of the presentation device 120, the remote control 128, the receiving device 118 and/or the mobile device 208, etc., and/or via an audio signal or visual signal presented by one or more of those devices. In response to user input received from one or more of the devices shown in FIG. 2, for example, user input received in responding to the prompt, the TV channel buffering and playback manager 100 will start the TV programming at the applicable point.

In some embodiments, to facilitate playing the TV programming from the correct point upon the user returning to a previous TV channel, when the user de-selects a TV channel the logic 202 causes the TV channel buffering and playback manager 100 to immediately, or nearly immediately, record an indication of the point the TV program being played on the TV channel is currently at. This indication may be recorded by the TV channel buffering and playback manager 100, for example, in the TV channel changing statistics file 204. When the user returns to that TV channel, the TV channel buffering and playback manager 100 starts playing the buffered content at the point indicated by or otherwise corresponding to the recorded indication.

Using such a recorded indication may be useful in instances when the TV program content of the current TV channel is already being buffered by the receiving device 118 while it is tuned to the TV channel. In some embodiments, such a recorded indication may be also or instead be useful when the TV program content is available in a local storage or remote storage digital video recorder (DVR), or via a cloud streaming service to indicate points within the TV program content to start playing. For example, this cloud streaming service source could be used by the receiving device while a user is viewing TV program content from the past and, if the user fast-forwards to real time, the content presented could be taken from the live broadcast from the local tuners or other sources as described elsewhere herein. In some example embodiments, the TV program content of the current TV channel is possibly already being buffered while the receiving device 118 is tuned to that TV channel to enable features such as pausing live television or a current broadcast, rewinding or fast-forwarding within buffered TV program content being played from the buffer, etc. In this instance, at least some of the same buffered TV program content that is, for example, used to enable pausing live television on that TV channel may be buffered TV program content 206, used by the buffering and playback manager 100 as buffered TV program content 206, or otherwise accessed by the buffering and playback manager 100 to start playing programming upon the user returning to the TV channel from the point the TV program was at when the user had left the TV channel.

FIG. 3 is a block diagram of a computing system for implementing example embodiments of a TV channel buffering and playback manager 100. FIG. 3 shows a receiving device computing system 300 that may be utilized to implement a TV channel buffering and playback manager 100. In one embodiment, the receiving device computing system 300 is part of a set-top box configured to receive, buffer, record and display programming on a presentation device 120, such as that shown in FIG. 3. In other embodiments, the receiving device computing system 300 is part of a presentation device, such as a television or a mobile device.

Note that one or more general purpose or special purpose computing systems/devices may be used to implement the TV channel buffering and playback manager 100. In addition, the computing system 300 may comprise one or more distinct computing systems/devices and may span distributed locations. Furthermore, each block shown may represent one or more such blocks as appropriate to a specific embodiment or may be combined with other blocks. Also, the TV channel buffering and playback manager 100 may be implemented in software, hardware, firmware, or in some combination to achieve the capabilities described herein.

In the embodiment shown, receiving device computing system 300 comprises a computer memory (“memory”) 301, a user interface display 302, one or more Central Processing Units (“CPU”) 303, Input/Output devices 304 (e.g., keyboard, mouse, RF or infrared receiving device, CRT or LCD display, and the like), other computer-readable media 305, and network connections 306. As mentioned above, the receiving device 118 may receive programming from the above-described receiving device antenna 114, and/or partially from, or entirely from, another source other than the above-described receiving device antenna 114. For example, some embodiments of the receiving device 118 may receive programming from program distributors 106 and/or content providers 104 via locally broadcast RF signals, cable, fiber optic, Internet media, or the like. Network connections 306 represent the interfaces, tuners, demodulators, demultiplexers, packet filters, network equipment, etc., of the receiving device that are configured and operable to receive data from and interface with the sources described herein, and convert the received signal(s) from these sources into a signal and/or format suitable for communication to a presentation device 120 or another device.

The TV channel buffering and playback manager 100 is shown residing in memory 301. In other embodiments, some portion of the contents and some of or all of the components of the TV channel buffering and playback manager 100 may be stored on and/or transmitted over the other computer-readable media 305. The components of the TV channel buffering and playback manager 100 execute on one or more CPUs 303 and cause the buffering of TV programming to occur and playback of TV programming to occur on presentation device 120 in a manner to facilitate a user avoiding missing television programming when changing between TV channels.

Other code or programs 330 (e.g., an audio/video processing module, a TV program guide manager module, a Web server, and the like) and potentially other data repositories, such as TV channel changing statistics 320, also reside in the memory 301, and preferably execute on one or more CPUs 303. Of note, one or more of the components in FIG. 3 may not be present in any specific implementation. For example, some embodiments may not provide other computer readable media 305 or a display 302.

In some embodiments, the TV channel buffering and playback manager 100 may include a buffering module 311, a playback module 312, a user interface manager 313, a buffered program data repository 315 that includes buffered programming, and a TV channel changing statistics file 316 that includes one or more TV channel changing statistics files. Other and/or different modules may be implemented. The TV channel buffering and playback manager 100 may interact via a network 350 with another home recording device 360 (e.g., a digital video recorder or local storage digital video recorder that continuously or continually records one or more live broadcasts of TV programs), program distributor 106, and home computing system 365 (e.g., a desktop computer, a laptop computer, tablet computer, mobile device, etc.).

The buffering module 311 provides the buffering functions of the TV channel buffering and playback manager 100. For example, the buffering module 311 initiates and performs buffering of TV programming received on one or more TV channels, by directing TV program content received by the computing system 300 to be stored in buffered program data repository 315. In one embodiment, the buffering module 311 may also be configured to store, in a corresponding TV channel changing statistics file 316, information and statistics, at least some of which are used by the TV channel buffering and playback manager 100 regarding TV channels, programming provided on various TV channels, historical occurrences of TV channel changes, points within buffered programming associated with the historical occurrences of TV channel changes, and other data as described herein. The playback module 312 may be configured to play particular buffered TV programming stored in the data depository 315 starting from the beginning of such buffered programming and/or from particular points within the buffered programming. The playback module 312 may be configured to access the corresponding TV channel changing statistics file for particular buffered TV program content to find the point within the buffered TV program content 206 from which to start playing the buffered TV program content 206 when the receiving device computing system 300 detects the receiving device 118 returning to a previous TV channel.

The user interface manager 313 provides a view and a controller that facilitate user interaction with the TV channel buffering and playback manager 100 and its various components. For example, the user interface manager 313 provides interactive graphical user interface screens and/or elements to notify the user of when buffered content is available when returning to a TV channel, provide prompts to the user inquiring whether the user want to return to a point in the TV programming at which the user left when tuning away from the TV channel, provide options for buffering TV program content, provide options for settings affecting the buffering of TV programming, etc. For example, in some embodiments, there is an option for the operator to communicate to the receiving device 118 which channels or events to buffer in order to avoid missing television programming on those TV channels or particular events when changing between TV channels based on the operator's own algorithms and/or heuristics such as, for example, analysis of data from “STB-health” channel change tracking statistics and/or other information described as being able to be stored in the TV channel changing statistics file 316. For example, the receiving device may be set or otherwise configured to preferentially buffer or otherwise record or store popular TV programs, programs other people are watching, have watched earlier broadcasts of, and/or have been the subject of trending topics on social networks, etc. The user interface manager 313 may also provide the user with controls for specifying the operation of the TV channel buffering and playback manager 100 including selection of a playback mode, pause, stop, slow motion, and other controls. The user interface manager 313 also receives input from a user (e.g., in the form of user interface events) and translates those inputs into the appropriate command for initiation by the TV channel buffering and playback manager 100.

In some embodiments, the TV channel buffering and playback manager includes an application program interface (“API”) that provides programmatic access to one or more functions of the TV channel buffering and playback manager 100. For example, such an API may provide a TV programmatic interface to one or more functions of the TV channel buffering and playback manager 100 that may be invoked by one of the other programs 330 or some other module. In this manner, the API may facilitate the development of third-party software, such as user interfaces, plug-ins, adapters (e.g., for integrating functions of the TV channel buffering and playback manager 100 into desktop applications), and the like. In addition, the API may be in at least some embodiments invoked or otherwise accessed via remote entities, such as the home recording device 360, the TV program distributor 106, the mobile device 208 (shown in FIG. 2) or the computing system 365, to access various functions of the TV channel buffering and playback manager 100. For example, operation of the computing system 365 or mobile device 208 may cause playback of particular buffered TV program content from buffered program data repository 315 on the mobile device 208 and/or computing system 365 by utilizing the TV channel buffering and playback manager 100 via the API.

In some embodiments, the TV channel buffering and playback manager 100 interacts with the home recording device 360 and/or the home computing system 365 for various purposes. For example, the TV channel buffering and playback manager 100 may schedule a recording to be made by the home recording device 360, such as when the TV channel buffering and playback manager 100 has multiple buffering events to occur at the same or overlapping time period. In other cases, such as when buffered program data store 315 has reached its maximum capacity or the computing system 300 is itself not configured to buffer programs, the TV channel buffering and playback manager 100 may utilize the home recording device 360 to buffer programming or may utilize recordings on a home recording device that is already recording the TV channels for other or similar purposes In various alternative embodiments, this other recording device may be accessible over a home LAN, over a WAN, or otherwise accessible via the communication system 108.

In some embodiments, the TV channel buffering and playback manager 100 may record TV program content of one or more TV channels on the recording device 360, using the recording device 360 as a secondary storage when available buffer memory in the buffered program data repository reaches a threshold amount and/or based on a TV channel priority setting of the of TV channels. When the receiving device computing system 300 switches back to a previous TV channel, the TV channel buffering and playback manager 100 accesses the TV program content stored on the recording device 360 for playback from the point the TV programming on that TV channel was at when the receiving device computing system 300 switched away from that TV channel. Such TV channel priority setting may also be stored, for example, in the TV channel changing statistics file 316. Also, to increase buffer capacity, in some embodiments utilization of transcoding by the buffering and playback manager 100 may be performed. For example, where a service is broadcast using MPEG-2 encoding, it could be transcoded by the buffering and playback manager 100 to H.264 (MPEG-4 Advanced Video Coding (AVC)) format or another format that is more storage space efficient and/or and more bandwidth efficient prior to buffering.

In some embodiments, each TV channel may have a TV channel buffer storage limit. The limit may be a limit in terms of, or be based on, time and/or memory amount used, over which the oldest data buffered for the TV channel will start to be overwritten or otherwise used to buffer newer data for the TV channel. This may be based on a buffer limit per-TV channel and/or combined with other memory management systems and priorities described herein. Also, in some embodiments, such limits may be selectable or otherwise configurable by the user or others. Additionally, in some embodiments, such limits may change dynamically based on preferences, user priorities, and/or other memory management systems and priorities described herein.

For example, in some embodiments, the buffering module 311 of the TV channel buffering and playback manager 100 may dynamically select a group and/or a size of a group of most recently visited TV channels for which to buffer or otherwise store TV program content based on an available buffer memory size of the buffered program data repository 315. In some embodiments, the TV channel buffering and playback manager 100 may be set by the user or otherwise configured to have the buffering module 311 continue to buffer the TV program content of a specified number of previous TV channels visited by the tuner of the receiving device 118, e.g., the previous five TV channels, to the extent buffer memory space is available in the buffered program data repository 315.

As one non-limiting example, if the memory size of the buffered program data repository 315 falls below a specified amount, then in some embodiments, only the most recent three or four TV channels of the previous five TV channels visited will continue to be buffered. This may occur, for example when a user switches from a first TV channel to a second TV channel. The buffering module 311 may start or continue to buffer the TV program content being broadcast on the first TV channel for a period of time until the user returns to the first TV channel. If the user does not return to the first TV channel for an amount of time such that the buffered program data repository 315 drops below a threshold amount, then the memory of the buffered program data repository 315 used to buffer the TV channel in the group which has not been visited for the relative longest period of time will start to be overwritten or otherwise used to continue buffering the most recently visited TV channel.

Although one prioritization for buffering a group of recently visited TV channels may be based on how recently one or more TV channels in the group were visited, other prioritization models for the buffering module 311 to decide which TV program content of which previously visited TV channels is to be buffered, or to which TV channels and/or programs memory is to be allocated for buffering, may be implemented by the TV channel buffering and playback manager 100. For example, in some embodiments, the buffering module 311 may be configured to give priority to buffering certain programs, certain TV channels, certain types of programs, certain types of TV channels, etc. In particular, such prioritization and buffer memory allocation models may be those based on, but are not limited to, one or more of: threshold available buffer memory; threshold available memory allocated for particular or selected TV channels and/or programs; indicated user TV channel preferences; historical TV channel viewing or visits; amounts of time one or more TV channels have been visited; amounts of time one or more TV channels have been visited over a period of time, average amounts of time one or more TV channels have been visited over a period time; current TV program content being broadcast on one or more TV channels, indicated user TV program content preferences; program titles; program subject; program metadata; an available amount of the buffer memory; a size of the group of most recently visited TV channels; which TV channels are visited for less than a minimum threshold amount of time; preferences indicated by user input; stored priorities between particular TV channels; a type of TV program content being broadcast; and/or an amount of time for which a TV channel of the plurality of TV channels is currently being visited; a user profile; a current user as indicated by a user profile; current user preferences as indicated by a user profile; etc.

Additionally, the TV channel buffering and playback manager 100 takes into consideration capacity and constraints of the network interface (represented by network connections 306). This includes taking into consideration the role and multiplicity of tuners, demodulators, demultiplexers and packet filters in implementing the system to facilitate avoiding missing television programming when changing between TV channels. The availability of tuner/demodulator units to isolate and demodulate RF transported signals may be tracked and managed by the TV channel buffering and playback manager 100 in a similar way to how buffer capacity, memory allocation and TV channels are managed by the TV channel buffering and playback manager 100 as described herein. In some embodiments, to do this, cases where there is one service (i.e., TV channel) of interest per RF channel (i.e., frequency band) and cases where multiple services of interest are multiplexed on the same RF channel are identified and managed by the buffering and playback manager 100.

For example, in cases where the receiving device 118 is limited to tuning to a limited number of TV channels at one time due to such network interface capacity and constraints, it may not be possible for the receiving device 118 to buffer, at the same time, over a certain number of TV channels that were previously visited, regardless of available buffer memory. Thus, procedures and methods analogous to those described herein for managing and tracking buffer memory capacity, prioritization, and allocation due to limited buffer memory resources may be applied to the tracking and managing the availability of tuner/demodulator units to isolate and demodulate RF transported signals. However, in embodiments where wide-band or full-band tuning/demodulation is available and implemented by the receiving device 118, these constraints may be relieved.

As another example, demultiplexer/packet filtering capacity matters generally for all packet based networks (e.g., Digital Video Broadcasting (DVB), Advanced Television Systems Committee (ATSC), Internet Protocol (IP), etc.). Depending on the nature of the protocols used by the receiving device 118, there may be quantization of capacity that is managed by the TV channel buffering and playback manager 100 in analogous ways to the management by the TV channel buffering and playback manager 100 of the tuner/demodulation capacity described herein. Management of the network interface (represented by network connections 306) may result in the same or similar processes, procedures, algorithms and methods as those for managing storage capacity and constraints herein. For example, the use by the buffering and playback manager 100 of the most recently used (MRU) and user, operator, and/or social network derived preference based algorithms for selection of which services (i.e., TV channels) are buffered and available as described herein may also be applied by the buffering and playback manager 100 to the management of the network interface as described herein.

The system to facilitate avoiding missing television programming when changing between TV channels can be applied on an event by event (e.g., a TV program by TV program) basis as well as a service by service (i.e., TV channel by TV channel) selection described herein. For example, once an event such as a TV program that has been selected by the receiving device 118 based on user input or by default operation has been entirely presented or is buffered pending presentation, then the network interface is free to tune, demodulate, demultiplex and/or filter for other events or services. For example, a user may be able to select or indicate particular programs which will be buffered such that when the user returns to the TV channel playing that program, the TV program will continue from the point it was at when the user de-selected the TV channel, but for other programs, this procedure will not be performed, as selectable by the user.

All or some of the data representing the above items on which the management of the network interface and/or management of the buffer memory resources (e.g., prioritization and/or memory allocation) may be based may be stored in the TV channel changing statistics file 316, in the other data repository 320, on an external storage device (not shown) such as mobile device 208 or other external device, or on a device at a location remote from the receiving device computing system 300, accessible by the TV channel buffering and playback manager 100 via the communication system 108 or other wired or wireless connection. Also, in various embodiments, any data described herein as being able to be stored in the TV channel changing statistics file 316 and/or TV channel changing statistics file 204 may be stored in the TV channel changing statistics file 316, in the other data repository 320, on an external storage device (not shown) such as mobile device 208 or other external device, or on a device at a location remote from the receiving device computing system 300, accessible by the TV channel buffering and playback manager 100 via the communication system 108 or other wired or wireless connection.

In various embodiments, the management of the network interface and/or management of the buffer memory resources (e.g., the prioritization and/or memory allocation model) implemented by the buffering module 311 described herein may be based on any single piece or any combination of data or information described herein as being able to be stored in the TV channel changing statistics file 316 and/or TV channel changing statistics file 204. Additionally, in some embodiments, any single piece or any combination of data or information described herein as being able to be stored in the TV channel changing statistics file 316 and/or TV channel changing statistics file 204, or parameter values associated therewith, can be configured, selected, input, set, indicated, dynamically changed, and/or chosen by a user, a manufacturer, a service center, and/or program distributor 106, etc.

In an example embodiment, components/modules of the TV channel buffering and playback manager 100 are implemented using standard programming techniques. For example, the TV channel buffering and playback manager 100 may be implemented as a “native” executable running on the CPU 303, along with one or more static or dynamic libraries. In other embodiments, the TV channel buffering and playback manager 100 may be implemented as instructions processed by a virtual machine that executes as one of the other programs 330. In general, a range of TV programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), declarative (e.g., SQL, Prolog, and the like).

In a software or firmware implementation, instructions stored in a memory cause, when executed, one or more processors of the computing system 300 to perform the functions of the TV channel buffering and playback manager 100. For example, instructions stored in memory when executed by a computer processor modify the data in the same or another memory address space, thus performing the functions of the TV channel buffering and playback manager 100. Alternatively instructions stored in memory when executed by a processor could modify the control registers of application specific integrated circuit (ASIC) to configure it to perform the function of the TV channel buffering, and/or it could modify the control registers of a different ASIC to configure it to perform the function of the playback manager. Such an ASIC may directly access and modify the memory of the computer processor without the intervention of the computer processor (DMA operation). In one embodiment, instructions, when executed cause the CPU 303 or some other processor, such as an I/O controller/processor, to buffer or otherwise record programming, such as by consuming program data and writing it to a disk or other storage device, by initiating a suitable DMA operation, or the like. Similarly, the CPU 303 or other processor may be configured to perform other operations such as playing recording in various playback modes.

The embodiments described above may also use synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported by a TV channel buffering and playback manager implementation. Also, functions could be implemented and/or performed by each component/module, and in different orders, and by different components/modules, yet still achieve the functions of the TV channel buffering and playback manager 100. For example, one way (broadcast) and/or two-way (interactive) wide area networks (WAN) may be used for content delivery. Utilizing two-way networks, the content may be buffered by the broadcaster on their equipment based on signalling returned via the WAN. Both types of networks may use storage local to the receiving device and under local control on the local area network (LAN).

In addition, programming interfaces to the data stored as part of the TV channel buffering and playback manager 100, such as in the buffered program data repository 315 and TV channel changing statistics file 316, can be available by standard mechanisms such as through C, C++, C#, and Java APIs; libraries for accessing files, databases, or other data repositories; through scripting languages such as XML; or through Web servers, FTP servers, or other types of servers providing access to stored data. The buffered program data repository 315 and TV channel changing statistics file 316 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of a TV channel buffering and playback manager.

Furthermore, in some embodiments, some or all of the components of the TV channel buffering and playback manager 100 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on, or transmitted/communicated by, various non-transitory or transitory computer-readable mediums (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

FIG. 4 is a timeline chart illustrating an example operation of a TV channel buffering and playback manager when changing between TV channels, according to one embodiment.

In the example shown in FIG. 4, a receiving device, for example, the receiving device 118 shown in FIGS. 1 and 2, starts out initially tuned to TV channel X. The receiving device then tunes to TV channel Y at the point within the TV programming being played on TV channel X designated by time code tₓ=h. For example, this may be caused by, or be otherwise in response to, a user using a remote control or other input device, such as remote control 128 or mobile device 208 shown in FIG. 2, to change a TV channel on the receiving device. Also, TV channel change (change of service) may occur as a result of a pre-set reminder configured to change the selected service to the service carrying the event the reminder was set for.

Note that in the present example, time code tₓ=h is a code indicative of a current index point within the TV program being played on TV channel X that the TV program is currently at, and is not a timestamp indicating the current time of day, an amount of time that has passed since the user tuned to TV channel X at actual time T=a, or necessarily indicative of an amount of actual time that has passed relative to any reference point. For example, while the receiving device is tuned to TV channel X starting at actual time T=A, the user inputs a command to the receiving device to pause the TV program content currently being broadcast on TV channel X when the TV program is at a particular time code, say tₓ=c. In one embodiment, TV channel X is already being buffered, for example, the buffering having started when the receiving device tuned to TV channel X. In an alternative embodiment, TV channel X may start to be buffered when the user inputs the pause command. While the TV program is paused, after some passage of time the user then inputs a command to the receiving device to start playing the paused program again. The content buffered in the TV channel X buffer will start to play from the point within the buffered TV program content indicated by this same time code tₓ=c at which the TV program being broadcast was paused. Thus, the value of the time codes (indicated by the lower case t) in the chart of FIG. 4 are indicative of particular index points within the corresponding TV program content, and not necessarily relative to the actual passage of time.

In some embodiments, Presentation Time Stamps (PTS) may be used as a source of the time code. PTS are time stamps included with the encoded video (e.g., Motion Picture Experts Groups (MPEG) encoded video) to indicate when a frame of video should be presented relative to other frames and to the System Time Clock (a clock in the receiving device used against which the presentation of audio, video, and/or subtitles, etc., are synchronized).

Also, at substantially T=b, directly or indirectly in response to the receiving device tuning away from TV channel X, the receiving device starts to buffer TV channel X if it is not already being buffered. If TV channel X is already being buffered, the receiving device continues to buffer TV channel X. Also, at substantially T=b, directly or indirectly in response to the receiving device tuning away from TV channel X, the receiving device records an indication of where the TV program being played on TV channel X was at when the receiving device de-selected TV channel X, by tₓ=h. This may be a point within the TV programming currently being broadcast on TV channel X, or a point within a current program buffer containing buffered TV program content of TV channel X in the case where the TV program content of TV channel X is already being or has been buffered. For example, while the receiving device is tuned to TV channel X, if the user inputs a command to the receiving device to pause the TV program content currently being broadcast on TV channel X at tₓ=c, the TV program content currently being broadcast on TV channel X may continue or start to be stored in TV channel X buffer. After some passage of time, the user then inputs a command to the receiving device to start playing the paused program again. At T=b, the user then changes the TV channel to TV channel Y at a point in the stored programming being played from the TV channel X buffer designated by tₓ=h.

Then, at substantially T=c, directly or indirectly in response to the receiving device tuning away from TV channel Y, in this case tuning back to TV channel X, the receiving device starts to buffer TV channel Y if it is not already being buffered. Directly or indirectly in response to the receiving device tuning back to TV channel X, the receiving device records an indication of where the TV program being played on TV channel Y was at when the receiving device de-selected TV channel Y, designated by t_{y}=i, and the receiving device will start to play the TV programming stored in the TV channel X buffer from the point in the TV program that was playing on TV channel X indicated by time code tₓ=h. In the present example, tₓ=h indicates the point in the TV programming stored in the TV channel X buffer that the TV program being played on TV channel X was at when the receiving device last de-selected TV channel X.

Then, at substantially T=d, directly or indirectly in response to the receiving device tuning away from TV channel X, in this case tuning back to TV channel Y, the receiving device starts to buffer TV channel X if it is not already being buffered. Directly or indirectly in response to the receiving device tuning back to TV channel Y at T=d, the receiving device records an indication of where the TV program being played on TV channel X was at when the receiving device de-selected TV channel X, designated by tₓ=n and will start to play the TV programming stored in the TV channel Y buffer from the point in the TV program indicated by time code t_{y}=i. In the present example, t_{y}=i indicates the point in the TV programming stored in the TV channel Y buffer that the TV program being played on TV channel Y was at when the receiving device last de-selected TV channel Y.

Note that although the TV channel X and TV channel Y buffers are designated separately, in some embodiments the buffers may be using the same physical memory device and/or the same logical memory area. In some embodiments TV channel X and TV channel Y may be the same buffer or share the same buffer, for example, in embodiments where only one TV channel is buffered at a time.

FIG. 5 is a flow diagram of first example method 500 for facilitating a user avoiding missing television programming when changing between TV channels, according to one embodiment. For example, the method 500 may be performed by one or more modules/components of the TV channel buffering and playback manager 100 executing on the receiving device 118, as described with respect to FIGS. 1 through 3.

At 502, the receiving device 118 plays TV program content on a first TV channel by at least one computer processor that is in control of the system;

At 504, the receiving device 118 switches to at least one TV channel different from the first TV channel in response to user input.

At 506, the receiving device 118 switches back to the first TV channel in response to user input.

At 508, the receiving device 118, in response to the switching back to the first TV channel, automatically continues to play the TV program content on the first TV channel from a point which the TV program content being played on the first TV channel approximately was at when the switching to the at least one different TV channel began.

FIG. 6 is a flow diagram of second example method 600 for facilitating a user avoiding missing television programming when changing between TV channels, according to one embodiment. For example, the method 600 may be performed by one or more modules/components of the TV channel buffering and playback manager 100 executing on the receiving device 118, as described with respect to FIGS. 1 through 3.

At 602, the receiving device 118 returns to presenting a TV channel of a plurality of TV channels.

At 604, the receiving device 118 continues to play TV program content that was being played on the TV channel of the plurality of TV channels starting from a point at which the TV program content being played on the TV channel approximately was when the receiving device last switched away from the TV channel.

At 606, the receiving device 118 returns to a different TV channel of the plurality of TV channels, at which point the method repeats starting at 604.

FIG. 7 is a flow diagram of third example method for facilitating a user avoiding missing television programming when changing between TV channels, according to one embodiment. For example, the method 700 may be performed by one or more modules/components of the TV channel buffering and playback manager 100 executing on the receiving device 118, as described with respect to FIGS. 1 through 3.

At 702, the receiving device 118 detects when a user tunes from a first TV channel to a second TV channel.

At 704, the receiving device 118, in response to the detecting when the user tunes to the second TV channel, records a reference associated with a point within buffered or stored TV program content of the first TV channel corresponding to a point that content being played on the first TV channel is approximately at when the user tuned to the second TV channel.

At 706, the receiving device 118, detects when the user tunes back to the first TV channel.

At 708, the receiving device 118, starts to play, based on the recorded reference and on the detecting when the user tunes back to the first TV channel, the buffered TV program content of the first TV channel from the point that the content being played on the first TV channel was approximately at when the user tuned to the second TV channel.

While various embodiments have been described hereinabove, it is to be appreciated that various changes in form and detail may be made without departing from the spirit and scope of the invention(s) presently or hereafter claimed.

1. A method in a television (TV) channel buffering and playback manager system, the method comprising:
playing TV program content on a first TV channel by at least one computer processor that is in control of the system;
switching, by the at least one computer processor, to at least one TV channel different from the first TV channel in response to user input;
switching, by the at least one computer processor, back to the first TV channel in response to user input; and
in response to the switching back to the first TV channel, playing, by the at least one computer processor, the TV program content on the first TV channel from a point at which the TV program content being played on the first TV channel approximately was when the switching to the at least one different TV channel began.

2. The method of claim 1 wherein the playing the TV program content on the first TV channel from the point at which the TV program content being played on the first TV channel was approximately when the switching to the at least one different TV channel began is additionally in response to receiving user input confirming a desire of the user to play the TV program content on the first TV channel from the point at which the TV program content being played on the first TV channel was when the switching to the at least one different TV channel began.

3. The method of claim 1 further comprising:
switching, by the at least one computer processor, between a plurality of TV channels over a period of time in response to user input, wherein the switching between the plurality of TV channels includes periods of time spent at each of the plurality of TV channels; and
facilitating, by the at least one computer processor, the user avoiding missing programming during the switching between the plurality of TV channels at least by, each time the at least one computer processor returns to a TV channel of the plurality of TV channels during the switching between the plurality of TV channels, playing, by the at least one computer processor, TV program content that was being played on the TV channel of the plurality of TV channels starting from a point at which the TV program content being played on the TV channel of the plurality of TV channels approximately was when the at least one processor last switched away from the TV channel of the plurality of TV channels.

4. The method of claim 3 wherein the plurality of TV channels is a group of most recently visited channels.

5. The method of claim 4 wherein the facilitating the user avoiding missing programming further includes excluding from the group of most recently visited TV channels, TV channels that are visited for less than a minimum threshold amount of time.

6. The method of claim 4 wherein the facilitating the user avoiding missing programming further includes:
recording TV program content of one or more of the plurality of TV channels on a secondary storage when available buffer memory for the one or more of the plurality of TV channels reaches a minimum threshold or based on a TV channel priority setting of the plurality of TV channels;
switching back to the one or more of the plurality of TV channels;
accessing the TV program content stored on the secondary storage for playback when the at least one processor switches back to the one or more of the plurality of TV channels; and
using the accessed TV program content stored on the secondary storage to continue playing TV program content that was being played on the one or more TV channels starting from a point at which the TV program content being played on the one or more TV channels approximately was when the at least one processor last switched away from the one or more TV channels.

7. The method of claim 4 wherein the facilitating the user avoiding missing TV programming further includes dynamically selecting a size of the group of most recently visited TV channels based on an available buffer memory size to store TV program content of the group of most recently visited TV channels.

8. The method of claim 4 wherein the facilitating, by the at least one computer processor, the user avoiding missing TV programming further includes:
allocating, by the at least one computer processor, buffer memory to the plurality of TV channels to store TV program content being played on each of the plurality of TV channels during the switching between the plurality of TV channels;
storing, by the at least one computer processor, TV program content being played on each of the plurality of TV channels during the switching between the plurality of TV channels in the allocated buffer memory;
upon revisiting any one of the plurality of TV channels during the switching between the plurality of TV channels, automatically outputting for presentation on a presentation device, using the TV program content stored in the allocated buffer memory, TV program content on the revisited TV channel that would have been output for presentation on the presentation device had the at least one processor not switched to another TV channel.

9. The method of claim 8 wherein the allocating includes:
for each TV channel of the plurality of TV channels, allocating buffer memory to the TV channel when the at least one processor first visits the TV channel during the switching between the plurality of TV channels.

10. The method of claim 8 wherein the allocating includes:
allocating the buffer memory to the plurality of TV channels based on one or more of: an available amount of the buffer memory; a size of the group of most recently visited TV channels; which TV channels of the plurality of TV channels are visited for less than a minimum threshold amount of time; preferences indicated by user input; stored priorities between particular TV channels in the plurality of TV channels; a type of TV program content being broadcast on the plurality of TV channels; and an amount of time for which a TV channel of the plurality of TV channels is currently being visited.

11. The method of claim 1 further comprising:
in conjunction with the switching back to the first TV channel, prompting the user, by the at least one processor, regarding whether the user desires the system to start playing TV program content currently being broadcast on the first TV channel or to automatically continue to play the TV program content on the first TV channel from the point at which the TV program content being played on the first TV channel was when the switching to the at least one different TV channel began; and
based on a corresponding response received after the prompting, automatically continuing to play, by the at least one processor, the TV program content on the first TV channel from the point at which the TV program content being played on the first TV channel approximately was when the switching to the at least one different TV channel began.

12. A television (TV) channel buffering and playback manager comprising:
at least one computer processor; and
a memory coupled to the at least one computer processor, wherein the at least one computer processor is configured to:
switch between presentation of a plurality of TV channels over a period of time in response to input from a user, wherein the switching between presentation of the plurality of TV channels includes periods of time spent at each of the plurality of TV channels; and
facilitate the user avoiding missing programming during the switching between the presentation of the plurality of TV channels at least by at least being configured to buffer TV programming at least by being configured to record points at which the TV programming TV program content being played on the TV channel is at in response to the input from the user causing the switching between presentation of a plurality of TV channels.

13. The system of claim 12 wherein the at least one computer processor is configured to facilitate the user avoiding missing TV programming by being configured to, each time the at least one computer processor returns to presenting a TV channel of the plurality of TV channels during the switching between the presentation of the plurality of TV channels, continue to play, by the at least one computer processor, TV program content that was being played on the TV channel of the plurality of TV channels starting from a point at which the TV program content being played on the TV channel of the plurality of TV channels approximately was when the at least one processor last switched away from presenting the TV channel of the plurality of TV channels plurality of TV channels is a group of most recently visited TV channels.

14. The system of claim 13 wherein the at least one computer processor is further configured to facilitate the user avoiding missing television programming by at least being further configured to exclude from the group of most recently visited TV channels, TV channels that are visited for less than a minimum threshold amount of time.

15. The system of claim 13 wherein the at least one computer processor is further configured to facilitate the user avoiding missing television programming by at least being further configured to:
record TV program content of one or more of the plurality of TV channels on a secondary storage when available buffer memory for the one or more of the plurality of TV channels reaches a minimum threshold or based on a TV channel priority setting of the plurality of TV channels;
switch back to presentation of the one or more of the plurality of TV channels;
access the TV program content stored on the secondary storage for playback when the at least one processor switches back to presentation of the one or more of the plurality of TV channels; and
use the accessed TV program content stored on the secondary storage to continue playing TV program content that was being played on the one or more TV channels starting from a point at which the TV program content being played on the one or more TV channels approximately was when the at least one processor last switched away from presentation of the one or more TV channels.

16. The system of claim 13 wherein the at least one computer processor is further configured to facilitate the user avoiding missing television programming by at least being further configured to dynamically select a size of the group of most recently visited TV channels based on an available buffer memory size to store TV program content of the group of most recently visited TV channels.

17. The system of claim 13 wherein the wherein the at least one computer processor is further configured to facilitate the user avoiding missing television programming by at least being further configured to:
allocate buffer memory to the plurality of TV channels to store TV program content being played on each of the plurality of TV channels during the switching between presentation of the plurality of TV channels;
store TV program content being played on each of the plurality of TV channels during the switching between presentation of the plurality of TV channels in the allocated buffer memory; and
upon revisiting any one of the plurality of TV channels during the switching between presentation of the plurality of TV channels, automatically output for presentation on a presentation device, using the TV program content stored in the allocated buffer memory, TV program content on the revisited TV channel that would have been output for presentation on the presentation device had the at least one processor not switched to presentation of another TV channel.

18. The method of claim 17 wherein the at least one computer processor is configured to allocate the buffer memory by at least being configured to:
for each TV channel of the plurality of TV channels, allocate buffer memory to the TV channel when the at least one processor first visits the TV channel during the switching between the presentation of plurality of TV channels.

19. A non-transitory computer-readable storage medium having computer executable instructions thereon that, when executed by at least one computer processor, cause at least one computer processor to:
detect when a user tunes from a first television (TV) channel to a second TV channel;
in response to the detecting when the user tunes to the second TV channel, record a reference associated with a point within buffered or stored TV program content of the first TV channel corresponding to a point that content being played on the first TV channel is approximately at when the user tuned to the second TV channel;
detect when the user tunes back to the first TV channel; and
start to play, based on the recorded reference and on the detecting when the user tunes back to the first TV channel, the buffered TV program content of the first TV channel from the point that the content being played on the first TV channel was approximately at when the user tuned to the second TV channel.

20. The non-transitory computer-readable storage medium of claim 19 wherein the reference is one or more of: a time reference, a time code, and an index reference.

21. The non-transitory computer-readable storage medium of claim 19 wherein the buffered or stored TV program content of the first TV channel is stored in non-volatile storage on a storage device located geographically remote from a presentation device on which the playing of the buffered or stored TV program content of the first TV channel occurs.
